(19) United States
(12) Patent Application Publication
(10) Pub. No.: US 2015/0322791 A1
(43) Pub. Date: Nov. 12, 2015

(54) Repair Method for Vortex Generator and a Kit for it

(71) Applicant: SENVION SE, Hamburg (DE)

(72) Inventor: Christian FLACH, Schacht Audorf (DE)

(21) Appl. No.: 14/707,095

(22) Filed: May 8, 2015

(30) Foreign Application Priority Data
May 9, 2014 (DE) 10 2014 106 529.8

(51) Int. Cl. F01D 5/00; F01D 5/14; F04D 29/18; F04D 29/60; F04D 29/26

(52) U.S. Cl. CPC F01D 5/005; F04D 29/60; F04D 29/26; F04D 29/18; F01D 5/147; F05D 2230/80

(57) ABSTRACT

The invention relates to a method for repairing a vortex generator (6) which projects from an outer skin (4) of a rotor blade, the vortex generator tip (65) of which is broken off and leaves behind a vortex generator stub (66) on the rotor blade outer skin (4), by the vortex generator stub (66) being ground down and a vortex generator crown (50) being fitted onto the ground-down vortex generator stub (66a).

### CROSS REFERENCE TO RELATED APPLICATION

This application takes priority from and claims the benefit of German Patent Application No. 10 2014 106 529.8 filed on May 9, 2014, under 35 USC §119 to, the contents of which are herein incorporated by reference.

### BACKGROUND OF THE INVENTION

1. Field of the Invention

The invention relates to a method for repairing a vortex generator which projects from an outer skin of a rotor blade, the tip of which vortex generator is broken off and leaves behind a vortex generator stub on the rotor blade outer skin, and also relates to a repair kit with a vortex generator crown and a template.

2. Description of the Related Art

Rotor blades with vortex generators are naturally well known in the prior art.

In wind power plants, it is known to provide the rotor blade with vortex generators to increase the lift. In this case, they are usually fins of triangular cross section which project in the main perpendicularly from a suction side of the rotor blade outer skin. The triangle is formed at right angles towards the rotor blade trailing edge, with a perpendicularly descending triangle side, and at an acute angle towards the rotor blade nose. The vortex generators can be arranged on the rotor blade outer skin at an angle or exactly parallel to the airflow direction. With flow around the rotor blade, each vortex generator generates a swirl downstream which separates downstream from the perpendicular edge of the vortex generator. These swirls or vortices prevent the forming of an excessively intense and excessively thick turbulent boundary layer between the outer skin of the rotor blade and the laminar airflow flowing around the rotor blade. As a result, a breaking away or separation of the laminar flow from the rotor blade is counteracted, and higher and more intense lift forces can act and develop on the rotor blade.

In the case of the known vortex generators, it is a problem that the vortex generators can break off. The risk of breaking off arises for example if climbers inspect the rotor blades from the outside and support themselves on the vortex generator. Hail damage can also occur on the vortex generator, however. The risk of the vortex generator breaking off is increased because embrittling as a result of UV irradiation begins in the course of time. Also, ice formation and bird strikes can lead to the vortex generator tips being damaged or broken off.

Vortex generators are frequently integrated into a baseplate. The arrangement consisting of vortex generator and baseplate is an integral component which is produced for example from plastic in an injection molding process. According to the prior art, the baseplate is replaced in total after a breaking off of the vortex generator from the baseplate, i.e. for this purpose the entire baseplate as a rule has to be removed from the rotor blade outer skin and be replaced by a new baseplate together with vortex generator. The baseplate is usually embedded in a recess in the rotor blade outer skin. It has to be adhesively fastened in there, and protruding edges and jumps have to be subsequently smoothed off in a laminating process or by grinding operations. These repair processes are decidedly time-intensive and laborious.

### SUMMARY OF THE INVENTION

It is therefore the object of the invention to provide a method referred to in the introduction which enables an inexpensive and faster repair of broken-off vortex generators, and also to provide a repair kit which enables a fast and inexpensive repair.

The object in its first aspect is achieved by means of a method with the features of claim 1.

According to the invention, it is intended to grind down a vortex generator stub which has formed by a tip of a vortex generator breaking off. In a further step, according to the invention a vortex generator crown is attached to the ground-down vortex generator stub. The vortex generator crown is preferably adhesively fastened by means of one or more adhesives.

The invention makes use of the knowledge that fatigue fractures in vortex generators which are connected integrally to a baseplate do not occur at the root of the vortex generator, that is to say at the transition between vortex generator and baseplate, but occur at a short distance from the baseplate. Virtually, only the tip of the vortex generator breaks off, and a vortex generator stub is left.

The vortex generator stub, however, is disadvantageously naturally different in its external shape even in the case of identically formed vortex generators of the same type. That is to say, the broken-off edges differ from each other in the case of each broken-off vortex generator. It is therefore not easily possible to fit a vortex generator crown onto a vortex generator stub with predictable strength and use of adhesive.

According to the invention, the vortex generator stub is ground down before fitting the vortex generator crown. The vortex generator stub is preferably ground down to a vortex generator stub of standardized size, especially of standardized height above the rotor blade outer wall.

In an especially preferred embodiment of the method according to the invention, a template is fitted onto the vortex generator stub and parts of the vortex generator stub which project beyond the template are ground down. As a result, it is possible according to the invention to provide a standardized ground-down vortex generator stub despite the different shape of the broken-off edges in different cases of damage.

Therefore, a standardized template is preferably fitted onto the vortex generator stub. Standardized in this case means that a standardized template is made available for each vortex generator type. The templates of different vortex generator types can differ from each other. Vortex generators of one type have the same external dimensions, i.e. they have an identical overall height, width and length and also an identical external shape.

The template which is allocated to the vortex generator via the construction type is fitted onto the broken-off vortex generator, and the broken-off edge is ground down to the height of the template so that the result is a ground-down vortex generator stub which is standardized in height and in width and length. Onto this, a similarly standardized vortex generator crown can be optimally fitted and adhesively fastened using a predetermined standardized amount of adhesive.

A socket of the vortex generator crown is preferably matched to the size of the ground-down vortex generator stub. The socket has slightly larger internal dimensions than the external dimensions of the ground-down vortex generator stub so that a thin gap is formed between socket and outer skin of the vortex generator stub and is filled with adhesive, preferably liquid adhesive, and creates an optimum and permanent adhesive bond. The gap width is favorably 0.5 mm or 1 mm, but other gap widths are also conceivable.

The vortex generator crown, on its rotor blade side, i.e. on the open encompassing socket edge facing away from the vortex generator tip, favorably has an adhesive strip, the protective layer of which is pulled off directly before the adhesive fastening of the vortex generator crown and frees the adhesive layer, and therefore the vortex generator crown can be adhesively fastened to the rotor blade outer skin.

A predetermined standardized amount of adhesive, preferably liquid adhesive, is poured into the socket of the vortex generator crown in advance and by pressing the vortex generator crown onto the ground-down vortex generator stub is distributed equally in the gap between inner wall of the socket and outer wall of the vortex generator stub. Air, and also small amounts of surplus adhesive, which are contained in the socket can escape through an outlet opening which totally penetrates the vortex generator crown and creates a connection between outer wall of the vortex generator crown and socket.

The object is fulfilled in its second aspect by means of a repair kit with the features of claim 7.

The repair kit is especially suitable for use in one of the aforesaid methods according to the invention.

According to the invention, the repair kit has a vortex generator crown and a template. The vortex generator crown has a socket and an external contour which is matched to a broken-off vortex generator tip. The socket is matched to a ground-down vortex generator stub.

The template is designed for fitting onto the broken-off vortex generator stub. It has an interior space which is complementarily matched to a vortex generator stub, with a large rotor blade-side opening and a small rotor blade rear-side opening. The template is complementarily matched in the sense that it can preferably be pulled onto the vortex generator stub in a form-fitting manner.

According to the invention, on the one hand the vortex generator crown and template are matched to each other, and on the other hand both are matched to a specific type of vortex generator, wherein the type of vortex generator is defined by its external dimensions.

The use of the repair kit is gathered from the method steps which are described above. The vortex generator crown preferably has an outlet for liquid adhesive and preferably also for air between socket and outer skin of the vortex generator crown. The outlet is preferably a hole, preferably a hole which is circular in cross section, between the outer skin of the vortex generator crown and the socket and enables the passage of air and also liquid adhesive so that the vortex generator crown can be fitted onto the ground-down vortex generator stub in a form-fitting manner.

In a further preferred embodiment of the repair kit according to the invention, the vortex generator crown has an adhesive strip which preferably totally encompasses the edge of the socket opening of the vortex generator crown.

### BRIEF DESCRIPTION OF THE DRAWINGS

The invention is described by way of example with reference to ten figures. In this case, in the drawing:

FIG. 1 shows a perspective view of a portion of a conventional rotor blade with four vortex generators,

FIG. 2 shows two vortex generators, arranged on a baseplate, for installing in a rotor blade according to FIG. 1,

FIG. 3a shows a typical pattern of damage to a vortex generator in FIGS. 1 and 2 in a side view,

FIG. 3b shows sectional view along the line A-A in FIG. 3a,

FIG. 4a shows a template according to the invention and vortex generator stub according to FIGS. 3a and 3b,

FIG. 4b shows a template fitted onto the vortex generator stub,

FIG. 4c shows a ground-down vortex generator stub with the template removed,

FIG. 4d shows a vortex generator crown fitted onto the ground-down vortex generator stub according to FIG. 4c,

FIG. 5a shows a sectional view along the line V-V in FIG. 4d,

FIG. 5b shows a sectional view of the vortex generator crown according to FIG. 5a.

### DETAILED DESCRIPTION OF THE SEVERAL EMBODIMENTS

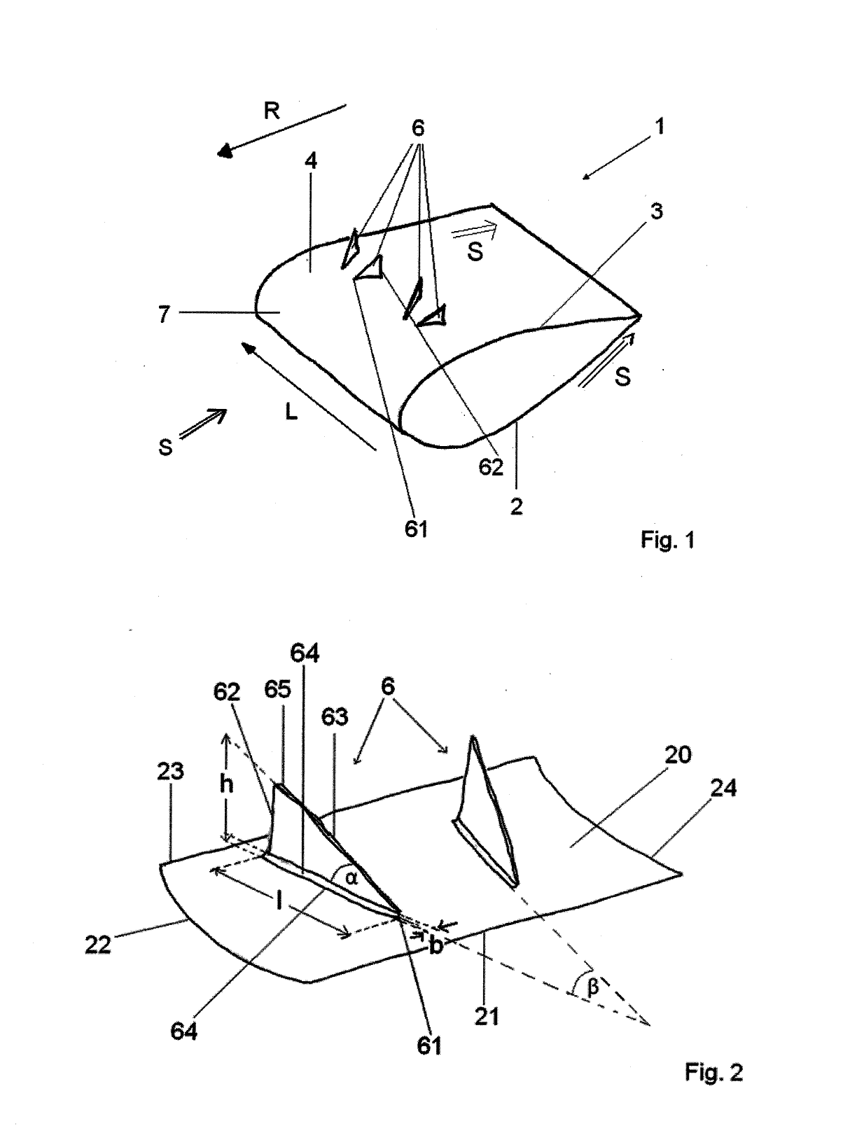

A rotor blade portion 1 is shown perspectively and schematically in FIG. 1. It has a pressure side 2 and a suction side 3. A cross section of the rotor blade portion 1 forms an aerodynamic profile along its entire extent in a longitudinal direction L.

On the suction side 3 of the rotor blade portion 1, four vortex generators 6 are arranged on a rotor blade outer skin 4. During operation, the rotor blade portion 1 and the entire rotor blade are subjected to an inflow on a rotor blade nose 7 which leads in a rotational direction R of the rotor. The inflow direction of an airflow S is represented by means of an air direction arrow. The rotor blade portion 1 is subjected to circumflow on the pressure side 2 and suction side 3 at the same time and on account of its aerodynamic profile creates a resulting force in the direction of the suction side 3 which sets the rotor in rotational motion.

On the suction side 3 of the rotor blade portion 1, in a side view, starting from the rotor blade hub which is arranged on the rotor blade on the inside in the longitudinal direction L, or rotor blade tip which is arranged on the outside, the vortex generators 6 are in the main of a triangularly-shaped design, wherein the triangle has a point 61 tapering towards the rotor blade nose 7 and a trailing edge 62, which drops perpendicularly to the rotor blade outer skin 4, is formed towards a rotor blade trailing edge 8.

When the airflow S circumflows the rotor blade portion 1, an air swirl, which is also called a vortex, is formed in each case behind each of the vortex generators 6. The vortex generators 6 are set at an angle to the direction of the airflow S. They are set at an angle to a cross section of the rotor blade portion 1 which is formed perpendicularly to the longitudinal direction L. In this embodiment, the vortex generators 6 extend towards each other in pairs in the direction of the rotor blade nose 7. The orientation of the vortex generators 6, which is angled in relation to the rotor blade nose 7, also determines the direction of the vortex which emanates from the vortex generator 6 downstream of the airflow S.

FIG. 2 shows two vortex generators 6, formed integrally on a baseplate 20, which extend towards each other in pairs at an angle β of about 30° to a leading edge 21 of the baseplate 20 which leads in the airflow direction S and faces the rotor blade nose 7. An upper side 63 of the vortex generators 6, which slopes straight and at an angle to the leading edge 21, forms an angle α of about 15° with the flat baseplate 20.

The magnitude of the vortex which emanates from the perpendicular trailing edge 62 depends greatly on an overall height h of the vortex generators 6. A width b and a length 1 of the vortex generator 6 play a rather subordinate role in contrast for the magnitude of the outgoing vortices.

The vortex generators 6 are arranged in a fixed position on the baseplate 20. The two vortex generators 6 and the baseplate 20 according to FIG. 2 are produced as a one-piece component, preferably in an injection molding process. As plastic for producing the baseplate 20, including the two vortex generators 6, the plastic Luran® is used in this case. The plastic Luran® is distributed by the BASF Company. Luran® is a styrene-acrylonitrile copolymer. However, other commercially available plastics are indeed also conceivable and applicable for producing the baseplate 20 together with vortex generators 6.

Since the baseplate 20 together with the two vortex generators 6 according to FIG. 2 have been produced in an injection molding process, the transitions between a root 64 of the vortex generator 6 and the baseplate 20 are particularly strong and also stable under operating loads. Fatigue fractures and other breaks occur only very rarely at the root 64 of the vortex generator 6.

The baseplate 20 together with the vortex generators 6 is inserted in finished rotor blades into the rotor blade outer skin 4 of the suction side 3 of the rotor blade. The baseplate 20 is preferably inserted in a recess of the rotor blade outer skin 4 and adhesively fastened there and, if necessary, overlaminated. It is also conceivable to adhesively fasten the baseplate 20 directly onto the rotor blade outer skin 4 by the beveled leading edge 21 and also three other beveled edges 22, 23, 24 which together delimit the baseplate in an encompassing manner.

During operation of a wind power plant with a baseplate 20 integrated into the rotor blade outer skin 4 and with vortex generators 6 projecting from it, fatigue fractures of projecting tips 65 of the vortex generators 6 can occur.

In addition to fatigue fractures of the projecting tips 65 of the vortex generators 6, fractures can also arise due to climbers during maintenance and repair operations as a result of accidental supporting or rope impact. In all cases, the vortex generators 6 no longer break off from the baseplate 20 at the root, however, because of the integral design with the baseplate 20, but the fractures extend transversely through the vortex generator 6 and the projecting tip 65 breaks off.

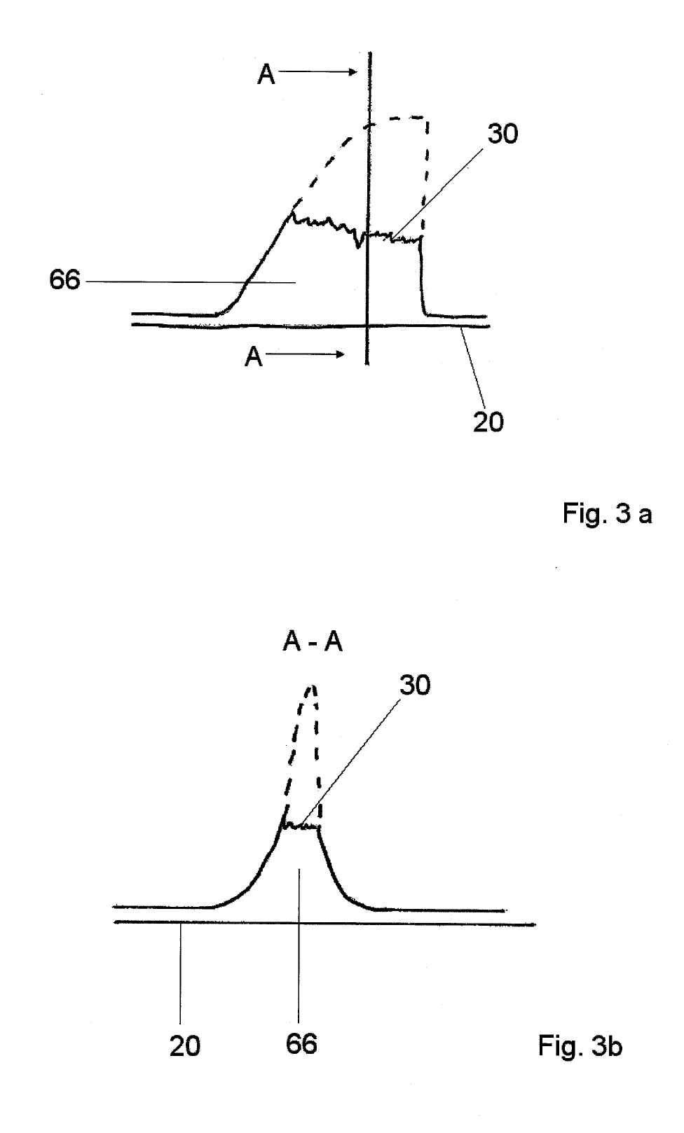

FIGS. 3a and 3b show a typical pattern of damage of a broken-off vortex generator 6 in a schematic representation, specifically in a side view in FIG. 3a and in a front view in FIG. 3b.

FIG. 3a shows that the projecting tip 65 of one of the vortex generators 6 in FIG. 2 is broken off along a broken-off edge 30. FIG. 3b shows the broken-off edge 30 in a front view. It is clear to see that a vortex generator stub 66 is formed and has the jagged, very unevenly formed broken-off edge 30.

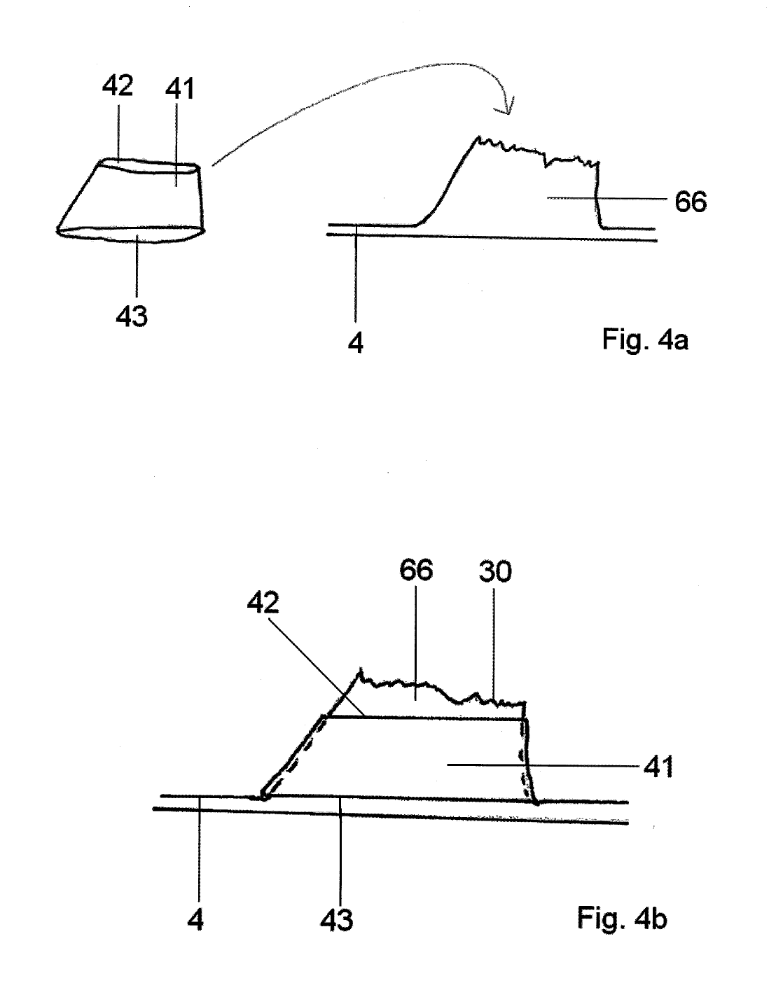

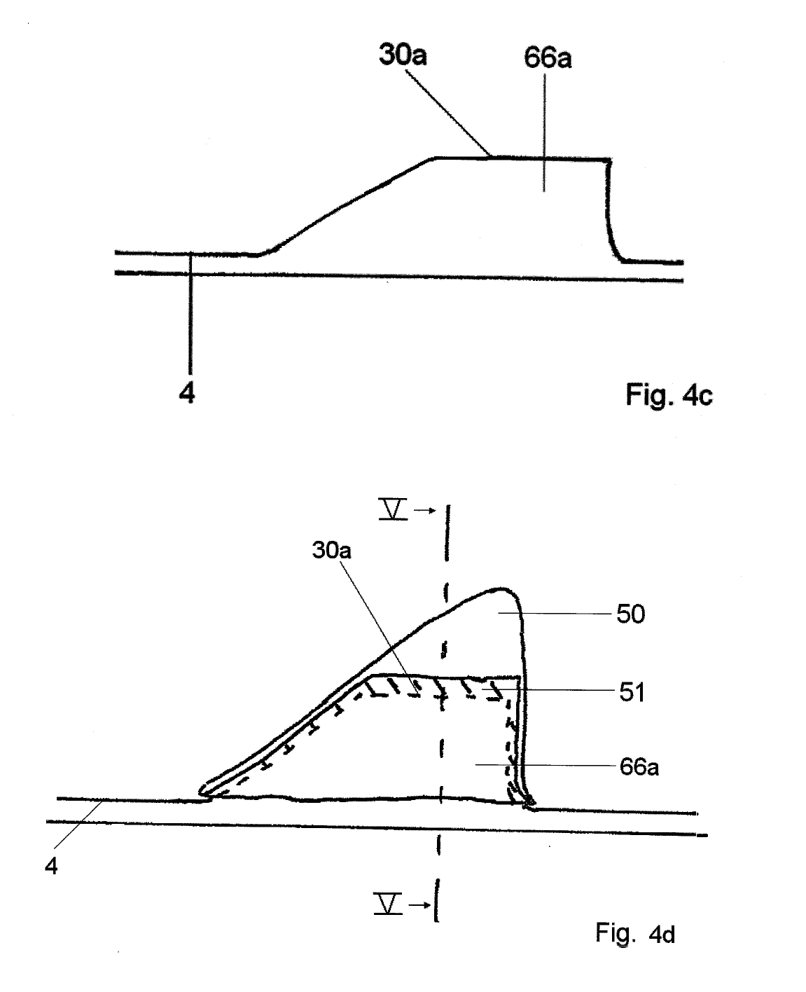

FIGS. 4a to 4d show in a schematic view steps of a repair method according to the invention which enables the vortex generator 6 according to FIG. 1 and FIG. 2 to be repaired in a cost-saving and time-saving manner while maintaining its original effectiveness after the repair. That is to say that the aerodynamic characteristics of the vortex generator 6 are similar after the repair, preferably being exactly like the aerodynamic characteristics of the original vortex generator 6. Furthermore, the stability of the repaired vortex generator 6 is similar, preferably being exactly like the stability of the original vortex generator 6.

Since the vortex generators 6 according to FIG. 2 have the broken-off edge 30 which creates the vortex generator stub 66 it is possible to grind down the vortex generator stub 66 and to use a ground-down vortex generator stub 66a as a mounting device for a vortex generator crown 50 according to the invention. In order to be able to produce a durable and stable connection between vortex generator stub 66 and vortex generator crown 50, it is expedient and provided according to the invention to grind the vortex generator stub 66 to a standardized size. To this end, according to FIG. 4a provision is made for a template 41 which has internal dimensions which correspond to external dimensions of the vortex generator 6 which is to be repaired. The template 41 resembles a short, tapering sleeve section with a small and a large opening 42, 43. The template, with its large opening 43 leading, is fitted from the top onto the vortex generator stub 66 until the larger opening 43 of the template 41 lies upon the rotor blade outer skin 4. This embodiment is shown in FIG. 4b.

The template 41 is dimensioned in its height h′ so that its rotor blade rear-side smaller opening 42 is arranged on the rotor blade side of the broken-off edge 30 when the template 41 is completely and rigidly fitted and pressed onto the vortex generator stub 66. In this way, the broken-off edge 30 is arranged completely outside the fitted template 41. The parts of the vortex generator stub 66 which project from the template 41 are ground down with a file (not shown) or with a grinding tool (not shown). To this end, the encompassing rim of the smaller opening 42 of the template 41 is especially of a friction-resistant and abrasion-resistant design.

After the grinding operation has been carried out, the template 41 can be removed and a standardized, ground-down vortex generator stub 66a according to FIG. 4c remains on the rotor blade outer skin 4. Onto this standardized and ground-down vortex generator stub 66a can be adhesively fastened the similarly standardized vortex generator crown 50 which is matched to this type of vortex generator. An adhesive 51 is provided with full surface contact between an inner wall of the vortex generator crown 50 and the outer wall of the ground-down vortex generator stub 66a.

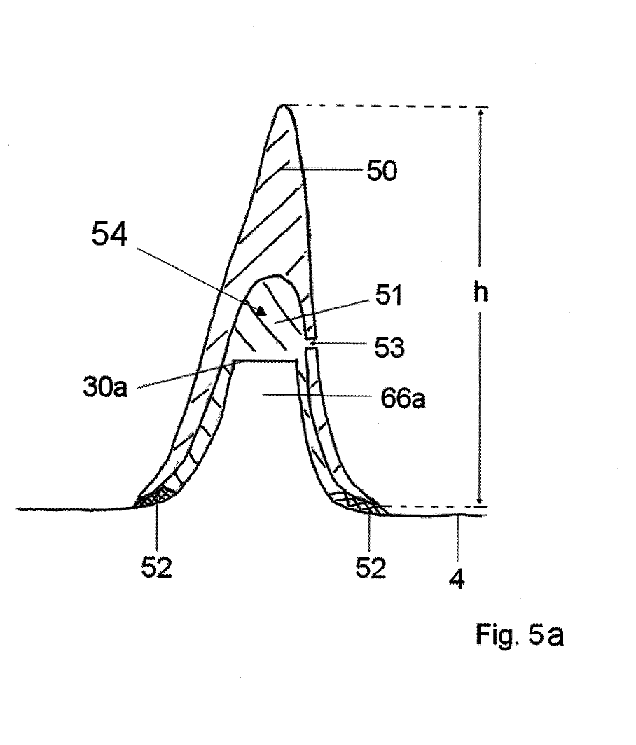

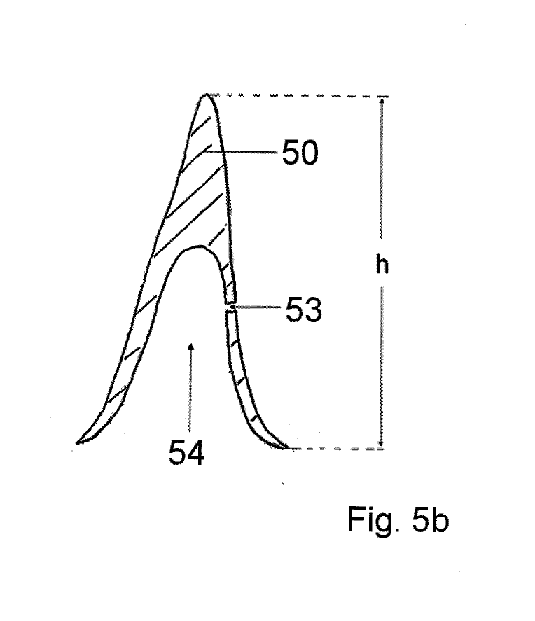

FIG. 5a shows a view along the line V-V in FIG. 4d. The ground-down vortex generator stub 66a, which after the grinding process is also formed integrally with the baseplate 20, has a flat and smooth ground-down broken-off edge 30a. A height of the ground-down vortex generator stub 66a corresponds to the height h′ of the template 41 and is therefore standardized. Standardized means in this case that with vortex generators 6 of a specific type use can be made in each case of the same template 41 of standardized size which is fitted onto the vortex generator stub 66 and in all cases of a broken-off, projecting vortex generator tip 65 leaves behind a ground-down vortex generator stub 66a which is identical in external dimensions after grinding down. Onto this now standardized and ground-down vortex generator stub 66a can be fitted the standardized vortex generator crown 50 with a standardized socket 54 which is matched to the ground-down vortex generator stub 66a. The socket 54 is a cavity which is slightly larger than the external dimensions of the ground-down vortex generator stub 66a so that by means of the liquid adhesive 51 the vortex generator crown 50 can be adhesively fastened with full surface contact to the ground-down vortex generator stub 66a. In the embodiment according to FIG. 5, provision is made on an outer rim of the socket 54 for an encompassing adhesive strip 52 which creates an immediate adhesive bond to the rotor blade outer skin 4 when the vortex generator crown 50 is being fitted onto the ground-down vortex generator stub 66a. The liquid adhesive 51 was poured into the socket 54 of the vortex generator crown in advance. The vortex generator crown 50 has a ventilation hole 53 a short distance above the height of the ground-down vortex generator stub 66a. Air and surplus adhesive 51 can escape through the ventilation hole 53 when the vortex generator crown 50 is being fitted onto the ground-down vortex generator stub 66a, and therefore the vortex generator crown 50 can be positioned in its ideal position on the ground-down vortex generator stub 66a and after setting of the liquid adhesive 51 can create a strong adhesive bond to the ground-down vortex generator stub 66a. The height h of the vortex generator crown 50 above the rotor blade outer wall 4 corresponds to the height h of the original vortex generator 6. The vortex generator crown 50 at the same distance above the rotor blade outer wall 4 is admittedly slightly wider than the original vortex generator 6. The width b of the vortex generator 6, however, has a smaller effect upon the magnitude and intensity of the vortices exerted by the vortex generator 6. The same applies to a length of the vortex generator crown 50.

FIG. 5b shows the vortex generator crown 50 in a sectional view according to FIG. 5a. The same designations also stand for the same components in this case. The vortex generator crown 50 has the height h. The vortex generator crown 50 consists of a solid material at its tip, whereas a region which in the installed state faces the ground-down vortex generator stub 66a features the socket 54 which in the main is formed as a recess and is dimensioned in its internal dimensions so that it can fully accommodate therein the ground-down vortex generator stub 66a which is ground down with the aid of the template 41 and still leaves a gap free between an inner wall of the socket 54 and an outer wall of the ground-down vortex generator stub 66a so that into this gap can be poured the adhesive 51 which envelops the ground-down vortex generator stub at the side and at the top.

### LIST OF DESIGNATIONS

1 Rotor blade portion
2 Pressure side
3 Suction side
4 Rotor blade outer skin
6 Vortex generator
7 Rotor blade nose
8 Rotor blade trailing edge
20 Baseplate
21 Leading edge
22 Edge
23 Edge
24 Edge
30 Broken-off edge
30a Ground-down broken-off edge
41 Template
42 Rotor blade rear-side small opening of the template
43 Rotor blade-side large opening of the template
50 Vortex generator crown
51 Adhesive
52 Adhesive strip
53 Ventilation hole
54 Socket
61 Tapering point of the vortex generator
62 Descending edge/perpendicular trailing edge
63 Upper side of the vortex generators
64 Vortex generator root
65 Projecting tip of the vortex generator
66 Vortex generator stub
66a Ground-down vortex generator stub
b Width of the vortex generator
h Overall height of the vortex generator
h′ Height of the template
l Length of the vortex generator
H Height of the vortex generator crown
L Longitudinal direction
R Rotational direction
S Airflow

What is claimed is:

1. A method for repairing a vortex generator (6) which projects from an outer skin (4) of a rotor blade, the vortex generator tip (65) of which is broken off and leaves behind a vortex generator stub (66) on the rotor blade outer skin (4),
by
the vortex generator stub (66) being ground down and a vortex generator crown (50) being fitted onto the ground-down vortex generator stub (66a).

2. The method as claimed in claim 1,
characterized in that a template (41) is fitted onto the vortex generator stub (66) and parts of the vortex generator stub (66) which project beyond the template (41) are ground down.

3. The method as claimed in claim 1,
characterized in that the vortex generator crown (50) is fitted onto the ground-down vortex generator stub (66a) by a socket (54) which is matched to the template (41).

4. The method as claimed in claim 1,
characterized in that the vortex generator crown (50) is adhesively fastened to the ground-down vortex generator stub (66a).

5. The method as claimed in claim 1,
characterized in that the vortex generator crown (50) is fixed on the ground-down vortex generator stub (66a) by means of an adhesive strip (52) which is arranged on the vortex generator crown (50).

6. The method as claimed in claim 1,
characterized in that the socket (54) is filled with adhesive (51) with which the vortex generator crown (50) is permanently adhesively fixed on the ground-down vortex generator stub (66a).

7. A repair kit with a vortex generator crown (50) and a template (41),
wherein the vortex generator crown (50) has an external contour which is matched to a vortex generator tip (65), and with a socket (54) which is matched to a ground-down vortex generator stub (66a), and wherein the template (41) has a sleeve-like interior space which is complementarily matched to a ground-down vortex generator stub (66a), with a large rotor blade-side opening (43) and a small rotor blade rear-side opening (42), and the template (41) is designed for fitting onto the broken-off vortex generator stub (66).

8. The repair kit as claimed in claim 7,
characterized by an outlet for liquid adhesive (51) between socket (54) and rotor blade outer skin (4).

9. The repair kit as claimed in claim 7,
characterized in that the vortex generator crown (50) has an adhesive strip (52) which preferably completely encompasses the socket opening.
